(19) United States
(12) Patent Application Publication
(10) Pub. No.: US 2018/0044556 A1
(43) Pub. Date: Feb. 15, 2018

(54) PRESSURE-SENSITIVE ADHESIVE COMPOSITION FOR OPTICAL FILM, PRESSURE-SENSITIVE ADHESIVE LAYER FOR OPTICAL FILM, PRESSURE-SENSITIVE ADHESIVE OPTICAL FILM AND IMAGE DISPLAY

(71) Applicant: Nitto Denko Corporation, Osaka (JP)

(72) Inventors: Atsushi Yasui, Osaka (JP); Yuusuke Toyama, Osaka (JP); Mizue Nagata, Osaka (JP); Tomoyuki Kimura, Osaka (JP); Masayuki Satake, Osaka (JP)

(73) Assignee: Nitto Denko Corporation, Osaka (JP)

(21) Appl. No.: 15/729,412

(22) Filed: Oct. 10, 2017

Related U.S. Application Data
(63) Continuation of application No. 12/943,162, filed on Nov. 10, 2010, now abandoned.

(30) Foreign Application Priority Data
Nov. 20, 2009 (JP) 2009-265548

(51) Int. Cl. C09J 7/02; C09J 133/02; C09J 133/06; C08F 220/26; C08F 220/18; C09J 133/08; C08F 220/28

(52) U.S. Cl. CPC C09J 7/0217; G02F 2202/28; C09J 2433/006; C09J 2401/006; C09J 2203/318; C09J 2201/606; C09J 133/08; Y10T 428/2891; C09J 133/02; C08F 220/28; C08F 220/26; C08F 220/18; Y10T 428/2848; C09J 133/06

(57) ABSTRACT

A pressure-sensitive adhesive composition for an optical film of the present invention includes a (meth)acrylic polymer(A) that comprises, as monomer units, 67 to 96.99% by weight of alkyl (meth)acrylate(a1), 1 to 20% by weight of benzyl (meth)acrylate(a2), 2 to 10% by weight of a carboxyl group-containing monomer(a3) and 0.01 to 3% by weight of a hydroxyl group-containing monomer(a4), has a weight average molecular weight(Mw) of 1,600,000 or more, and satisfy a weight average molecular weight(Mw)/number average molecular weight(Mn) ratio of 1.8 to 10. The pressure-sensitive adhesive composition can satisfy durability that does not cause peeling, separation at the state in which the optical film was attached, and can form a pressure-sensitive adhesive layer capable of improving display non-uniformity caused by a white display leakage at a peripheral portion.

### CROSS-REFERENCE TO RELATED APPLICATIONS

This application is a Continuation of U.S. application Ser. No. 12,943,162, filed Nov. 10, 2010 and which is based upon and claims the benefit of priority from the prior Japanese Patent Application No. 2009-265548, filed on Nov. 20, 2009, the entire contents of which are incorporated herein by reference.

### BACKGROUND OF THE INVENTION

### Field of the invention

The present invention relates to a pressure-sensitive adhesive composition excellent in adhesion state for an optical film, and a pressure-sensitive adhesive optical film including an optical film and a pressure-sensitive adhesive layer formed on at least one side of the optical film. The present invention further relates to an image display such as a liquid crystal display and an organic electroluminescence (EL) display, including the pressure-sensitive adhesive optical film. The optical film may be a polarizing plate, a retardation plate, an optical compensation film, a brightness enhancement film, a laminate thereof, or the like.

### Description of the Related Art

The image-forming system of liquid crystal displays or the like requires polarizing elements to be placed on both sides of a liquid crystal cell, and generally polarizing plates are attached thereto. Besides polarizing plates, a variety of optical elements have been used for liquid crystal panels to improve display quality. For example, there are used retardation plates for prevention of discoloration, viewing angle expansion films for improvement of the viewing angle of liquid crystal displays, and brightness enhancement films for enhancement of the contrast of displays. These films are generically called optical films.

When the optical members such as optical films are attached to a liquid crystal cell, pressure-sensitive adhesives are generally used. Bonding between an optical film and a liquid crystal cell or between optical films is generally performed with a pressure-sensitive adhesive in order to reduce optical loss. In such a case, a pressure-sensitive adhesive optical film including an optical film and a pressure-sensitive adhesive layer previously formed on one side of the optical film is generally used, because it has some advantages such as no need for a drying process to fix the optical film.

Properties required of the pressure-sensitive adhesive include such workability that it can be worked without fouling or dropout after a pressure-sensitive adhesive layer is formed on an optical film, and such properties that it does not cause a problem such as peeling or separation in a durability test by heating, humidifying or the like, which is generally performed as an environmental acceleration test.

In addition to durability, pressure-sensitive adhesives for optical films are required to have the ability to improve display non-uniformity such as peripheral non-uniformity or corner non-uniformity, caused by a white display leakage at a peripheral portion. It is proposed that a (meth)acrylic polymer as a base polymer of pressure-sensitive adhesives for optical films should be formed using alkyl (meth)acrylate (a1), an aromatic ring-containing (meth)acrylic monomer (a2), and a functional group-containing monomer such as a carboxyl group-containing monomer (a3) or a hydroxyl group-containing monomer (a4) (see JP-A No. 2005-053976, JP-A No. 2007-138056, JP-A No. 2007-169329, JP-A No. 2008-170949). However, pressure-sensitive adhesives for optical films, which contain a (meth)acrylic polymer as a base polymer as described in above Japanese Patent Publications, have been required to offer higher characteristics for durability and display non-uniformity such as peripheral non-uniformity or corner non-uniformity, caused by a white display leakage at a peripheral portion, and none of above Japanese Patent Publications can satisfy all of such characteristics requirements.

### SUMMARY OF THE INVENTION

An object of the present invention is to provide a pressure-sensitive adhesive composition for an optical film, which can satisfy durability that does not cause peeling, separation or the like at the state in which the optical film was attached, and can form a pressure-sensitive adhesive layer capable of improving display non-uniformity caused by a white display leakage at a peripheral portion.

An object of the present invention is also to provide a pressure-sensitive adhesive layer formed from the pressure-sensitive adhesive composition for an optical film, and a further object of the present invention is to provide a pressure-sensitive adhesive optical film comprising such a pressure-sensitive adhesive layer and to provide an image display including such a pressure-sensitive adhesive optical film.

As a result of investigations for solving the problems, the inventors have found the pressure-sensitive adhesive composition for an optical film described below and have completed the present invention.

The present invention relates to a pressure-sensitive adhesive composition for an optical film, including a (meth)acrylic polymer (A) that contains, as monomer units, 67 to 96.99% by weight of alkyl (meth)acrylate (a1), 1 to 20% by weight of benzyl (meth)acrylate (a2), 2 to 10% by weight of a carboxyl group-containing monomer (a3) and 0.01 to 3% by weight of a hydroxyl group-containing monomer (a4), has a weight average molecular weight (Mw) of 1,600,000 or more, and satisfy a weight average molecular weight (Mw)/number average molecular weight (Mn) ratio of 1.8 to 10.

In the pressure-sensitive adhesive composition for an optical film, the hydroxyl group-containing monomer (a4) preferably comprises 4-hydroxybutyl (meth)acrylate.

In the pressure-sensitive adhesive composition for an optical film preferably further includes a crosslinking agent (B). The crosslinking agent (B) is preferably at least one selected from an isocyanate crosslinking agent, an epoxy crosslinking agent and a peroxide crosslinking agent.

In the pressure-sensitive adhesive composition for an optical film preferably further includes a silyl group-containing compound (C).

The present invention also relates to a pressure-sensitive adhesive layer for an optical film, including a product formed from the above pressure-sensitive adhesive composition for an optical film.

The present invention also relates to a pressure-sensitive adhesive optical film, including an optical film; and the above pressure-sensitive adhesive layer for an optical film formed on at least one side of the optical film. The optical film on which the pressure-sensitive adhesive layer is formed preferably comprises a triacetylcellulose resin, a (meth)acrylic resin or a norbornene resin. The pressure-sensitive adhesive optical film further may include an undercoat layer that is provided between the optical film and the pressure-sensitive adhesive layer for the optical film.

The present invention also relates to an image display, including at least one piece of the above pressure-sensitive adhesive optical film.

The pressure-sensitive adhesive composition for an optical film of the present invention includes a (meth)acrylic polymer(A) as a base polymer that contains, as a given amount of monomer units, benzyl (meth)acrylate (a2), a carboxyl group-containing monomer (a3) and a hydroxyl group-containing monomer (a4), and has a specific weight average molecular weight and a specific distribution of molecular weight. A pressure-sensitive adhesive optical film having a pressure-sensitive adhesive layer obtained from the optical film pressure-sensitive adhesive composition containing the (meth)acrylic polymer(A) having the specified composition has good durability to various optical films (such as triacetylcellulose resins, (meth)acrylic resins or norbornene resins) and can suppress peeling, separation and so on at the state in which the optical film was attached to a liquid crystal cell or the like.

If an image display, such as a liquid crystal display, produced with an pressure-sensitive adhesive optical film such as a pressure-sensitive adhesive polarizing plate is placed under heat or humid conditions, display non-uniformity such as peripheral non-uniformity or corner non-uniformity due to a white display leakage at a peripheral portion of the liquid crystal panel or the like may occur to cause poor display. However, the pressure-sensitive adhesive layer of the pressure-sensitive adhesive optical film of the present invention, which is produced with the optical film pressure-sensitive adhesive composition described above, can suppress display non-uniformity at the peripheral portion of a display screen.

### DETAILED DESCRIPTION OF THE PREFERRED EMBODIMENTS

The pressure-sensitive adhesive composition for an optical film of the present invention includes a (meth)acrylic polymer (A) as a base polymer. The (meth)acrylic polymer (A) contains, as monomer units, 67 to 96.99% by weight of alkyl (meth)acrylate (a1), 1 to 20% by weight of benzyl (meth)acrylate (a2), 2 to 10% by weight of a carboxyl group-containing monomer (a3) and 0.01 to 3% by weight of a hydroxyl group-containing monomer(a4). As used herein, “(meth)acrylate” refers to acrylate and/or methacrylate, and “meth” has the same meaning with respect to the present invention.

The alkyl (meth)acrylate (a1) used to form the main skeleton of the (meth)acrylic polymer (A) may have a straight- or branched-chain alkyl group of 1 to 18 carbon atoms. Examples of such an alkyl group include methyl, ethyl, propyl, isopropyl, butyl, isobutyl, amyl, hexyl, cyclohexyl, heptyl, 2-ethylhexyl, isooctyl, nonyl, decyl, isodecyl, dodecyl, isomyristyl, lauryl, tridecyl, pentadecyl, hexadecyl, heptadecyl, and octadecyl groups. These may be used singly or in any combination. The average number of carbon atoms in the alkyl group is preferably from 3 to 9.

The (meth)acrylic polymer (A) contains benzyl (meth)acrylate (a2). Benzyl (meth)acrylate (a2) has a benzene ring structure, which can satisfy durability and improve display non-uniformity caused by a white display leakage at a peripheral portion, when used in the specified amount in combination with the carboxyl group-containing monomer (a3) and the hydroxyl group-containing monomer (a4).

The carboxyl group-containing monomer (a3) is a compound having a carboxyl group in the structure and having a polymerizable unsaturated double bond such as a (meth)acryloyl group or a vinyl group. Examples of the carboxyl group-containing monomer (a3) include (meth)acrylic acid, carboxyethyl (meth) acrylate, carboxypentyl (meth) acrylate, itaconic acid, maleic acid, fumaric acid, and crotonic acid. In particular, the carboxyl group-containing monomer (a3) is preferably acrylic acid in view of copolymerizability, cost, and adhesive properties.

The hydroxyl group-containing monomer (a4) is a compound having a hydroxyl group in the structure and having a polymerizable unsaturated double bond such as a (meth)acryloyl group or a vinyl group. Examples of the hydroxyl group-containing monomer (a4) include 2-hydroxyethyl (meth)acrylate, 3-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth) acrylate, 12-hydroxylauryl (meth) acrylate, and (4-hydroxymethylcyclohexyl)-methyl acrylate. In particular, the hydroxyl group-containing monomer (a4) is preferably 2-hydroxyethyl (meth)acrylate or 4-hydroxybutyl (meth)acrylate in view of durability, and 4-hydroxybutyl (meth)acrylate is particularly preferred.

If the pressure-sensitive adhesive composition contains a crosslinking agent, these copolymerizable monomers can work as reactive sites with the crosslinking agent. The carboxyl group-containing monomer (a3) and the hydroxyl group-containing monomer (a4) have high reactivity with an intermolecular crosslinking agent and therefore are preferably used to improve the cohesiveness or heat resistance of the pressure-sensitive adhesive layer to be obtained. The carboxyl group-containing monomer (a3) is preferred in terms of providing both durability and reworkability at the same time, and the hydroxyl group-containing monomer (a4) is preferred in terms of reworkability.

The (meth)acrylic polymer (A) contains the specified weight ratio amount of each of the monomer units, based on the total amount (100% by weight) of all monomer components. The weight ratio of the alkyl (meth)acrylate (a1) may be determined as the weight ratio of the balance monomer other than the non-alkyl (meth)acrylate monomers, which is specifically from 67 to 96.99% by weight, preferably from 71 to 89.99% by weight, more preferably from 77.5 to 85.97% by weight. The weight ratio of the alkyl (meth)acrylate (a1) is preferably set in the above range in order to ensure reliable adhesive property.

The weight ratio of the benzyl (meth)acrylate (a2) is from 1 to 20% by weight, preferably from 7 to 18% by weight, more preferably from 10 to 16% by weight. If the weight ratio of the benzyl (meth)acrylate (a2) is more than 20% by weight or less than 1% by weight, a sufficient suppress in display non-uniformity cannot be achieved at the peripheral portion of a display screen.

The weight ratio of the carboxyl group-containing monomer (a3) is from 2 to 10% by weight, preferably from 3 to 10% by weight, more preferably from 4 to 6% by weight. If the weight ratio of the carboxyl group-containing monomer (a3) is less than 2% by weight, satisfactory durability cannot be achieved. If it is more than 10% by weight, satisfactory reworkability cannot be achieved.

The weight ratio of the hydroxyl group-containing monomer (a4) is from 0.01 to 3% by weight, preferably from 0.01 to 1% by weight, more preferably from 0.03 to 0.5% by weight. If the weight ratio of the hydroxyl group-containing monomer (a4) is less than 0.01% by weight, satisfactory durability cannot be achieved. If it is more than 3% by weight, satisfactory durability cannot be achieved.

The (meth)acrylic polymer (A) does not have to contain any additional monomer unit other than the monomer units described above. In order to improve the adhesive property or the heat resistance, however, one or more copolymerizable monomer having an unsaturated double bond-containing polymerizable functional group such as a (meth)acryloyl group or a vinyl group may be introduced by copolymerization.

Examples of such a copolymerizable monomer include acid anhydride group-containing monomers such as maleic anhydride and itaconic anhydride; caprolactone adducts of acrylic acid; sulfonic acid group-containing monomers such as allylsulfonic acid, 2-(meth)acrylamido-2-methylpropanesulfonic acid, (meth) acrylamidopropanesulfonic acid, and sulfopropyl (meth)acrylate; and phosphate group-containing monomers such as 2-hydroxyethylacryloyl phosphate.

Examples of such a monomer for modification also include (N-substituted) amide monomers such as (meth)acrylamide, N,N-dimethyl(meth)acrylamide, N-butyl(meth)acrylamide, N-methylol(meth)acrylamide, and N-methylolpropane(meth)acrylamide; alkylaminoalkyl (meth)acrylate monomers such as aminoethyl (meth)acrylate, N,N-dimethylaminoethyl (meth)acrylate, and tert-butylaminoethyl (meth)acrylate; alkoxyalkyl (meth)acrylate monomers such as methoxyethyl (meth)acrylate and ethoxyethyl (meth)acrylate; succinimide monomers such as N-(meth)acryloyloxymethylenesuccinimide, N-(meth)acryloyl-6-oxyhexamethylenesuccinimide, N-(meth)acryloyl-8-oxyoctamethylenesuccinimide, and N-acryloylmorpholine; maleimide monomers such as N-cyclohexylmaleimide, N-isopropylmaleimide, N-laurylmaleimide, and N-phenylmaleimide; and itaconimide monomers such as N-methylitaconimide, N-ethylitaconimide, N-butylitaconimide, N-octylitaconimide, N-2-ethylhexylitaconimide, N-cyclohexylitaconimide, and N-laurylitaconimide. Among the above modification monomers, amino group-containing monomers such as alkylaminoalkyl (meth)acrylate monomers have a strong odor and are relatively difficult to handle and therefore are not preferred for the production. Such amino-group containing monomers are preferably not used in combination with a peroxide, because they are particularly difficult to handle in such a case. In an embodiment of the present invention, the modification effect of an amino group-containing monomer can be obtained, when the carboxyl group-containing monomer (a3) is used in a larger amount than usual.

Examples of the modification monomer also include vinyl monomers such as vinyl acetate, vinyl propionate, and N-vinylcaprolactam; cyanoacrylate monomers such as acrylonitrile and methacrylonitrile; epoxy group-containing acrylic monomers such as glycidyl (meth)acrylate; glycol acrylic ester monomers such as polyethylene glycol (meth) acrylate, polypropylene glycol (meth) acrylate, methoxyethylene glycol (meth)acrylate, and methoxypolypropylene glycol (meth)acrylate; and acrylate ester monomers such as tetrahydrofurfuryl (meth)acrylate, fluoro(meth)acrylate, silicone (meth)acrylate, and 2-methoxyethyl acrylate. Further examples include isoprene, butadiene, isobutylene, vinyl ether, and so on.

Besides the above, a silicon atom-containing silane monomer may be exemplified as the copolymerizable monomer. Examples of the silane monomers include 3-acryloxypropyltriethoxysilane, vinyltrimethoxysilane, vinyltriethoxysilane, 4-vinylbutyltrimethoxysilane, 4-vinylbutyltriethoxysilane, 8-vinyloctyltrimethoxysilane, 8-vinyloctyltriethoxysilane, 10-methacryloyloxydecyltrimethoxysilane, 10-acryloyloxydecyltrimethoxysilane, 10-methacryloyloxydecyltriethoxysilane, and 10-acryloyloxydecyltriethoxysilane.

Copolymerizable monomers that may be used also include polyfunctional monomers having two or more unsaturated double bonds such as (meth)acryloyl groups or vinyl groups, which include (meth)acrylate esters of polyhydric alcohols, such as tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate, and caprolactone-modified dipentaerythritol hexa(meth)acrylate; and compounds having a polyester, epoxy or urethane skeleton to which two or more unsaturated double bonds are added in the form of functional groups such as (meth)acryloyl groups or vinyl groups in the same manner as the monomer component, such as polyester (meth)acrylates, epoxy (meth)acrylates and urethane (meth)acrylates.

The weight ratio content of the copolymerizable monomer used to form the (meth)acrylic polymer (A) is preferably from 0 to about 10%, more preferably from 0 to about 7%, even more preferably from 0 to about 5%, based on the total weight ratio (100% by weight) of all the monomer components of the (meth)acrylic polymer (A).

In an embodiment of the present invention, the (meth)acrylic polymer (A) to be used generally has a weight average molecular weight of 1,600,000 or more. In view of durability, particularly, heat resistance, the polymer (A) to be used preferably has a weight average molecular weight of 1,700,000 to 3,000,000, more preferably 1,800,000 to 2,800,000, even more preferably 1,900,000 to 2,500,000. A weight average molecular weight of less than 1,600,000 is not preferred in view of heat resistance. A weight average molecular weight of more than 3,000,000 is also not preferred, because the durability may be reduced in such a case. The ratio of the weight average molecular weight (Mw)/the number average molecular weight (Mn), which indicates the molecular weight distribution, is preferably from 1.8 to 10, more preferably from 2 to 7, even more preferably from 2 to 5. A molecular weight distribution (Mw/Mn) of more than 10 is not preferred in view of durability. The weight average molecular weight and molecular weight distribution (Mw/Mn) refer to a polystyrene-equivalent weight average molecular weight measured and calculated by gel permeation chromatography (GPC).

For the production of the (meth)acrylic polymer (A), any appropriate method may be selected from known production methods such as solution polymerization, bulk polymerization, emulsion polymerization, and various radical polymerization methods. The resulting (meth)acrylic polymer (A) may be any type of copolymer such as a random copolymer, a block copolymer and a graft copolymer.

In a solution polymerization process, for example, ethyl acetate, toluene or the like is used as a polymerization solvent. In a specific solution polymerization process, for example, the reaction is performed under a stream of inert gas such as nitrogen at a temperature of about 50 to about 70° C. for about 5 to about 30 hours in the presence of a polymerization initiator.

Any appropriate polymerization initiator, chain transfer agent, emulsifying agent and so on may be selected and used for radical polymerization. The weight average molecular weight of the (meth)acrylic polymer (A) may be controlled by the reaction conditions including the amount of addition of the polymerization initiator or the chain transfer agent and monomers concentration. The amount of the addition may be controlled as appropriate depending on the type of these materials.

Examples of the polymerization initiator include, but are not limited to, azo initiators such as 2,2′-azobisisobutylonitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, 2,2′-azobis(N,N′-dimethyleneisobutylamidine), and 2,2′-azobis[N-(2-carboxyethyl)-2-methylpropionamidine]hydrate (VA-057, manufactured by Wako Pure Chemical Industries, Ltd.); persulfates such as potassium persulfate and ammonium persulfate; peroxide initiators such as di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutylperoxy-2-ethyl hexanoate, di(4-methylbenzoyl) peroxide, dibenzoyl peroxide, tert-butylperoxyisobutylate, 1,1-di(tert-hexylperoxy)cyclohexane, tert-butylhydroperoxide, and hydrogen peroxide; and redox system initiators of a combination of a peroxide and a reducing agent, such as a combination of a persulfate and sodium hydrogen sulfite and a combination of a peroxide and sodium ascorbate.

One of the above polymerization initiators may be used alone, or two or more thereof may be used in a mixture. The total content of the polymerization initiator is preferably from about 0.005 to 1 part by weight, more preferably from about 0.02 to about 0.5 parts by weight, based on 100 parts by weight of the monomer.

For example, when 2,2′-azobisisobutyronitrile is used as a polymerization initiator for the production of the (meth)acrylic polymer with the above weight average molecular weight, the polymerization initiator is preferably used in a content of from about 0.06 to 0.2 parts by weight, more preferably of from about 0.08 to 0.175 parts by weight, based on 100 parts by weight of the total content of the monomer components.

Examples of the chain transfer agent include lauryl mercaptan, glycidyl mercaptan, mercaptoacetic acid, 2-mercaptoethanol, thioglycolic acid, 2-ethylhexyl thioglycolate, and 2,3-dimercapto-1-propanol. One of these chain transfer agents may be used alone, or two or more thereof may be used in a mixture. The total content of the chain transfer agent is preferably 0.1 parts by weight or less, based on 100 parts by weight of the total content of the monomer components.

Examples of the emulsifier used in emulsion polymerization include anionic emulsifiers such as sodium lauryl sulfate, ammonium lauryl sulfate, sodium dodecylbenzenesulfonate, ammonium polyoxyethylene alkyl ether sulfate, and sodium polyoxyethylene alkyl phenyl ether sulfate; and nonionic emulsifiers such as polyoxyethylene alkyl ether, polyoxyethylene alkyl phenyl ether, polyoxyethylene fatty acid ester, and polyoxyethylene-polyoxypropylene block polymers. These emulsifiers may be used alone, or two or more thereof may be used in combination.

The emulsifier may be a reactive emulsifier. Examples of such an emulsifier having an introduced radical-polymerizable functional group such as a propenyl group and an allyl ether group include Aqualon HS-10, HS-20, KH-10, BC-05, BC-10, and BC-20 (each manufactured by Dai-ichi Kogyo Seiyaku Co., Ltd.) and Adekaria Soap SE1ON (manufactured by Asahi Denka Kogyo K.K.). The reactive emulsifier is preferred, because after polymerization, it can be incorporated into a polymer chain to improve water resistance. Based on 100 parts by weight of the total monomer component, the emulsifier is preferably used in a content of 0.3 to 5 parts by weight, more preferably of 0.5 to 1 parts by weight, in view of polymerization stability or mechanical stability.

The pressure-sensitive adhesive composition of the present invention also includes a crosslinking agent(B). An organic crosslinking agent or a polyfunctional metal chelate may also be used as the crosslinking agent (B). Examples of the organic crosslinking agent include an isocyanate crosslinking agent, an epoxy crosslinking agents, a peroxide crosslinking agents and an imine crosslinking agents. The polyfunctional metal chelate may comprise a polyvalent metal and an organic compound that is covalently or coordinately bonded to the metal. Examples of the polyvalent metal atom include Al, Cr, Zr, Co, Cu, Fe, Ni, V, Zn, In, Ca, Mg, Mn, Y, Ce, Sr, Ba, Mo, La, Sn, and Ti. The organic compound has a covalent or coordinate bond-forming atom such as an oxygen atom. Examples of the organic compound include alkyl esters, alcohol compounds, carboxylic acid compounds, ether compounds, and ketone compounds.

The crosslinking agent (B) to be used is preferably selected from an isocyanate crosslinking agent, an epoxy crosslinking agent and a peroxide crosslinking agent.

The compound for the isocyanate crosslinking agent is a compound having two or more isocyanate groups in one molecule. Examples of such a compound include isocyanate monomers such as tolylene diisocyanate, chlorophenylene diisocyanate, tetramethylene diisocyanate, xylylene diisocyanate, diphenylmethane diisocyanate, and hydrogenated diphenylmethane diisocyanate, and isocyanate compounds produced by adding any of these isocyanate monomers to trimethylolpropane or the like; and urethane prepolymer type isocyanates produced by the addition reaction of isocyanurate compounds, burette type compounds, or polyether polyols, polyester polyols, acrylic polyols, polybutadiene polyols, polyisoprene polyols, or the like. Particularly preferred is a polyisocyanate compound such as one selected from the group consisting of hexamethylene diisocyanate, hydrogenated xylylene diisocyanate, and isophorone diisocyanate, or a derivative thereof. Examples of one selected from the group consisting of hexamethylene diisocyanate, hydrogenated xylylene diisocyanate, and isophorone diisocyanate, or a derivative thereof include hexamethylene diisocyanate, hydrogenated xylylene diisocyanate, isophorone diisocyanate, polyol-modified hexamethylene diisocyanate, polyol-modified hydrogenated xylylene diisocyanate, trimer-type hydrogenated xylylene diisocyanate, and polyol-modified isophorone diisocyanate. The listed polyisocyanate compounds are preferred, because their reaction with a hydroxyl group quickly proceeds as if an acid or a base contained in the polymer acts as a catalyst, which particularly contributes to the rapidness of the crosslinking.

The epoxy crosslinking agent is a compound having two or more epoxy groups (glycidyl groups) in one molecule. Examples of the epoxy crosslinking agent include ethylene glycol diglycidyl ether, polyethylene glycol diglycidyl ether, diglycidyl terephthalate, spiroglycol diglycidyl ether, diglycidylaminomethyl cyclohexane, tetraglycidyl xylenediamine, and polyglycidyl meta-xylenediamine and the like.

Any peroxide capable of generating active radical species by heating or photoirradiation and promoting the crosslinking of the base polymer in the pressure-sensitive adhesive composition may be appropriately used. In view of workability and stability, a peroxide with a one-minute half-life temperature of 80° C. to 160° C. is preferably used, and a peroxide with a one-minute half-life temperature of 90° C. to 140° C. is more preferably used.

Examples of the peroxide for use in the present invention include di(2-ethylhexyl) peroxydicarbonate (one-minute half-life temperature: 90.6° C.), di(4-tert-butylcyclohexyl) peroxydicarbonate (one-minute half-life temperature: 92.1° C.), di-sec-butyl peroxydicarbonate (one-minute half-life temperature: 92.4° C.), tert-butyl peroxyneodecanoate (one-minute half-life temperature: 103.5° C.), tert-hexyl peroxypivalate (one-minute half-life temperature: 109.1° C.), tert-butyl peroxypivalate (one-minute half-life temperature: 110.3° C.), dilauroyl peroxide (one-minute half-life temperature: 116.4° C.), di-n-octanoylperoxide (one-minute half-life temperature: 117.4° C.), 1,1,3,3-tetramethylbutylperoxy-2-ethyl hexanoate (one-minute half-life temperature: 124.3° C.), di(4-methylbenzoyl) peroxide (one-minute half-life temperature: 128.2° C.), dibenzoyl peroxide (one-minute half-life temperature: 130.0° C.), tert-butyl peroxyisobutylate (one-minute half-life temperature: 136.1° C.), and 1,1-di(tert-hexylperoxy)cyclohexane (one-minute half-life temperature: 149.2° C.). In particular, di(4-tert-butylcyclohexyl) peroxydicarbonate (one-minute half-life temperature: 92.1° C.), dilauroyl peroxide (one-minute half-life temperature: 116.4° C.), dibenzoyl peroxide (one-minute half-life temperature: 130.0° C.), or the like is preferably used, because they can provide high crosslinking reaction efficiency.

The half life of the peroxide is an indicator of how fast the peroxide can be decomposed and refers to the time required for the amount of the peroxide to reach one half of its original value. The decomposition temperature required for a certain half life and the half life time obtained at a certain temperature are shown in catalogs furnished by manufacturers, such as “Organic Peroxide Catalog, 9th Edition, May, 2003” furnished by NOF CORPORATION.

The amount of the crosslinking agent (B) to be used is preferably from 0.01 to 20 parts by weight, more preferably from 0.03 to 10 parts by weight, based on 100 parts by weight of the (meth)acrylic polymer (A). If the amount of the crosslinking agent (B) is less than 0.01 parts by weight, the cohesive strength of the pressure-sensitive adhesive may tend to be insufficient, and foaming may occur during heating. If the amount of the crosslinking agent (B) is more than 20 parts by weight, the humidity resistance may be insufficient, so that peeling may easily occur in a reliability test or the like.

The crosslinking agent (B) is preferably an isocyanate crosslinking agent, a peroxide crosslinking agent, or an epoxy crosslinking agent in view of the pot life of the coating liquid, adhesive characteristics, durability, and crosslink stability. In particular, an isocyanate crosslinking agent is preferably used in combination with a peroxide crosslinking agent, so that a good balance can easily be achieved between the adhesive properties, durability and crosslink stability.

One of the isocyanate crosslinking agents may be used alone, or a mixture of two or more of the isocyanate crosslinking agents may be used. The total content of the polyisocyanate compound crosslinking agent(s) is preferably from 0.01 to 2 parts by weight, more preferably from 0.02 to 2 parts by weight, even more preferably from 0.05 to 1.5 parts by weight, based on 100 parts by weight of the (meth)acrylic polymer (A). The content may be appropriately controlled taking into account the cohesive strength or the prevention of peeling in a durability test or the like.

One of the peroxide crosslinking agents may be used alone, or a mixture of two or more of the peroxide crosslinking agent may be used. The total content of the peroxide(s) is preferably from 0.01 to 2 parts by weight, more preferably from 0.04 to 1.5 parts by weight, even more preferably from 0.05 to 1 part by weight, based on 100 parts by weight of the (meth)acrylic polymer(A). The content of the peroxide(s) may be appropriately selected in this range in order to control the workability, reworkability, crosslink stability or peeling properties.

The amount of decomposition of the peroxide may be determined by measuring the peroxide residue after the reaction process by high performance liquid chromatography (HPLC).

More specifically, for example, after the reaction process, about 0.2 g of each pressure-sensitive adhesive composition is taken out, immersed in 10 ml of ethyl acetate, subjected to shaking extraction at 25° C. and 120 rpm for 3 hours in a shaker, and then allowed to stand at room temperature for 3 days. Thereafter, 10 ml of acetonitrile is added, and the mixture is shaken at 25° C. and 120 rpm for 30 minutes. About 10 μl of the liquid extract obtained by filtration through a membrane filter (0.45 μm) is subjected to HPLC by injection and analyzed so that the amount of the peroxide after the reaction process is determined.

One of the epoxy crosslinking agents may be used alone, or a mixture of two or more of the epoxy crosslinking agents may be used. The total content of the epoxy crosslinking agent(s) is preferably from 0.01 to 2 parts by weight, more preferably from 0.04 to 1.5 parts by weight, even more preferably from 0.05 to 1 part by weight, based on 100 parts by weight of the (meth)acrylic polymer (A). The content of the epoxy crosslinking agent(s) may be appropriately selected in this range in order to control the workability, reworkability, crosslink stability, or peeling properties.

The pressure-sensitive adhesive composition of the present invention may further contain a silyl group-containing compound (C). The durability or the reworkability can be improved using the silyl group-containing compound (C).

The silyl group-containing compound (C) may be a silane coupling agent (C1). Examples of silane coupling agent (C1) include epoxy group-containing silane coupling agents such as 3-glycidoxypropyltrimethoxysilane, 3-glycidoxypropyltriethoxysilane, 3-glycidoxypropylmethyldiethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropylmethyldimethoxysilane, and 3-triethoxysilyl-N-(1,3-dimethylbutylidene)propylamine; (meth)acrylic group-containing silane coupling agents such as 3-acryloxypropyltrimethoxysilane and 3-methacryloxypropyltriethoxysilane; and isocyanate group-containing silane coupling agents such as 3-isocyanatepropyltriethoxysilane.

One of the silane coupling agent (C1) may be used alone, or a mixture of two or more of the silane coupling agent (C1) may be used. The total content of the silane coupling agent (s) (c1) is preferably from 0.001 to 2 parts by weight, more preferably from 0.01 to 1 part by weight, even more preferably from 0.02 to 1 part by weight, still more preferably from 0.05 to 0.6 parts by weight, based on 100 parts by weight of the (meth)acrylic polymer (A). The content of the silane coupling agent (C1) may be appropriately amount in order to control improve durability and maintain adhesive strength to the optical member such as a liquid crystal cell.

The silyl group-containing compound (C) may also be a polyether compound (C2) having a polyether skeleton and a reactive silyl group represented by formula (1): —SiRₐM₃₋ₐ at at least one end, wherein R represents a monovalent organic group having 1 to 20 carbon atoms and optionally having a substituent, M represents a hydroxyl group or a hydrolyzable group, and <a> represents an integer of 1 to 3, provided that two or more R groups, if any, may be the same or different, and two or more M groups, if any, may be the same or different. The polyether compound (C2) is particularly preferred, because it is highly effective in improving the reworkability.

In the process of bonding a pressure-sensitive adhesive optical film to a liquid crystal cell, they may be misaligned, or foreign matter may be caught on the bonding surface. Even in such a case, satisfactory reworkability allows easy peeling of the optical film from the liquid crystal panel. After a pressure-sensitive adhesive optical film is bonded to a liquid crystal cell, various processes may be performed over a long time, or the product may be stored at high temperature. Even in such a case, satisfactory reworkability prevents an increase in the adhesive strength to the liquid crystal cell or the like and allows easy peeling of the pressure-sensitive adhesive optical film from the liquid crystal cell or the like, which makes it possible to reuse the liquid crystal cell without any damage or fouling. In particular, it has been difficult to peel off a pressure-sensitive adhesive optical film from a conventional large liquid crystal cell. According to the present invention, however, a pressure-sensitive adhesive optical film can easily be peeled off even from a large liquid crystal cell.

The polyether compound (C2) has at least one reactive silyl group of the above formula in one molecule at the end. When the polyether compound (C2) is a straight-chain compound, said polyether compound (C2) can have one or two reactive silyl groups of the above formula at the ends and preferably has two at the ends. When the polyether compound (C2) is a branched-chain compound, its ends include the ends of the main chain and the branched chain(s), and it has at least one reactive silyl group of the above formula at the end, and preferably has two or more, more preferably three or more reactive silyl groups of the above formula, depending on the number of the ends.

The reactive silyl group-containing polyether compound (C2) may have the reactive silyl group in at least part of the molecular ends and at least one, preferably 1.1 to five, more preferably 1.1 to three reactive silyl groups in part of the molecular ends.

In the reactive silyl group represented by formula (1), R is a monovalent organic group having 1 to 20 carbon atoms and optionally having a substituent. R is preferably a straight- or branched-chain alkyl group of 1 to 8 carbon atoms, a fluoroalkyl group of 1 to 8 carbon atoms, or a phenyl group, more preferably a alkyl group of 1 to 6 carbon atoms, particularly preferably a methyl group. If two or more R groups are present in the same molecule, they may be the same or different. M is a hydroxyl group or a hydrolyzable group. The hydrolyzable group is directly bonded to the silicon atom and can form a siloxane bond by a hydrolysis reaction and/or a condensation reaction. Examples of the hydrolyzable group include a halogen atom, an alkoxy group, an acyloxy group, an alkenyloxy group, a carbamoyl group, an amino group, an aminooxy group, and a ketoxymate group. When the hydrolyzable group has a carbon atom or atoms, the number of the carbon atoms is preferably 6 or less, more preferably 4 or less. In particular, an alkoxy or alkenyloxy group of 4 or less carbon atoms is preferred, and a methoxy group or an ethoxy group is particularly preferred. When two or more M groups are present in the same molecule, they may be the same or different.

The reactive silyl group represented by formula (1) is preferably an alkoxysilyl group represented by formula (2):

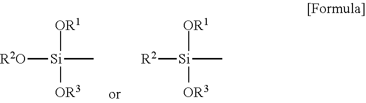

wherein R¹, R² and R³ each represent a monovalent hydrocarbon group of 1 to 6 carbon atoms and may be the same or different in the same molecule.

Examples of R¹, R² and R³ in the alkoxysilyl group represented by formula (2) include a straight- or branched-chain alkyl group of 1 to 6 carbon atoms, a straight- or branched-chain alkenyl group of 2 to 6 carbon atoms, a cycloalkyl group of 5 to 6 carbon atoms, and a phenyl group. Examples of —OR¹, —OR² and —OR³ in the formula include a methoxy group, an ethoxy group, a propoxy group, a propenyloxy group, and a phenoxy group. In particular, a methoxy group and an ethoxy group are preferred, and a methoxy group is particularly preferred.

The polyether skeleton of the polyether compound (C2) preferably has a straight- or branched-chain oxyalkylene group of 1 to 10 carbon atoms as a repeating structural unit. The structural unit of the oxyalkylene group preferably has 2 to 6 carbon atoms, more preferably three carbon atoms. The repeating structural unit of the oxyalkylene group may be a single repeating structural unit or a block or random copolymer unit comprising two or more oxyalkylene groups. Examples of the oxyalkylene group include an oxyethylene group, an oxypropylene group, and an oxybutylene group. Among these oxyalkylene groups, an oxypropylene group (particularly —CH₂CH(CH₃)O—) is preferred as the structural unit, because of easiness of the production of the material, the stability of the material, and so on.

In a preferred mode, the main chain of the polyether compound (C2) consists essentially of a polyether skeleton in addition to the reactive silyl group. In this context, “the main chain consists essentially of a polyoxyalkylene chain” means that the main chain may contain a small amount of any other chemical structure. For example, when the repeating structural unit of the oxyalkylene group is produced to form a polyether skeleton, it may also contain the chemical structure of an initiator and a linking group or the like to the reactive silyl group. The content of the repeating structural unit of the oxyalkylene group of the polyether skeleton is preferably 50% by weight or more, more preferably 80% by weight or more, based on the total weight of the polyether compound (C2).

The polyether compound (C2) may be a compound represented by formula (3): RₐM₃₋ₐSi—X—Y-(AO)ₙ—Z, wherein R represents a monovalent organic group having 1 to 20 carbon atoms and optionally having a substituent, M represents a hydroxyl group or a hydrolyzable group, <a> represents an integer of 1 to 3, provided that two or more R groups, if any, may be the same or different, and two or more M groups, if any, may be the same or different, AO represents a straight- or branched-chain oxyalkylene group of 1 to 10 carbon atoms, n represents the average addition molar number of the oxyalkylene groups, which is from 1 to 1,700, X represents a straight- or branched-chain alkylene group of 1 to 20 carbon atoms, Y represents an ether bond, an ester bond, a urethane bond, or a carbonate bond and Z represents a hydrogen atom, a monovalent hydrocarbon group of 1 to 10 carbon atoms, a group represented by formula (3A) : —Y₁—X—SiRₐM₃₋ₐ, wherein R, M and X have the same meanings as defined above, and Y₁ represents a single bond, a —CO— bond, a —CONH— bond, or a —COO— bond, or a group represented by formula (3B): -Q{—(OA)ₐ-Y—X—SiRₐM₃₋ₐ}ₘ, wherein R, M, X, and Y have the same meanings as defined above, OA has the same meaning as AO defined above, n has the same meaning as defined above, Q represents a divalent or polyvalent hydrocarbon group of 1 to 10 carbon atoms, and m represents a number that is the same as the valence of the hydrocarbon group.

In formula (3), X is a straight- or branched-chain alkylene group of 1 to 20 carbon atoms, preferably 2 to 10 carbon atoms, more preferably three carbon atoms.

In formula (3), Y is a linking group that may be formed by a reaction with the terminal hydroxyl group of the oxyalkylene group of the polyether skeleton. Y is preferably an ether bond or a urethane bond, more preferably a urethane bond.

Z corresponds to a hydroxy compound having a hydroxyl group, which is involved as an initiator for the oxyalkylene polymer in the production of the compound represented by formula (3). When formula (3) has one reactive silyl group at one end, Z at the other end is a hydrogen atom or a monovalent hydrocarbon group of 1 to 10 carbon atoms. When Z is a hydrogen atom, the structural unit used is the same as that of the oxyalkylene polymer. When Z is a monovalent hydrocarbon group of 1 to 10 carbon atoms, the hydroxy compound used has one hydroxyl group.

When formula (3) has two or more reactive silyl groups at the ends, Z corresponds to formula (3A) or (3B). When Z corresponds to formula (3A), the same structural unit as that of the oxyalkylene polymer is used for the hydroxy compound. When Z corresponds to formula (3B), the hydroxy compound used differs from the structural unit of the oxyalkylene polymer and has two hydroxyl groups. When Z corresponds to formula (3A), Y¹ is a linking group that may be formed by a reaction with the terminal hydroxyl group of the oxyalkylene group of the polyether skeleton as in the case of Y.

In view of reworkability, the polyether compound (C2) represented by formula (3) is preferably a compound represented by formula (4): Z⁰-A²-O-(A¹O)ₙ—Z¹, wherein A¹O represents an oxyalkylene group of 2 to 6 carbon atoms, n represents the average addition molar number of A¹O, which is from 1 to 1,700, and Z¹ represents a hydrogen atom or -A²-Z⁰, wherein A² represents an alkylene group of 2 to 6 carbon atoms,

a compound represented by formula (5): Z⁰-A²-NHCOO-(A¹O)ₙ—Z², wherein A¹O represents an oxyalkylene group of 2 to 6 carbon atoms, n represents the average addition molar number of A¹O, which is from 1 to 1,700, and Z² represents a hydrogen atom or —CONH-A²-Z⁰, wherein A² represents an alkylene group of 2 to 6 carbon atoms, or
a compound represented by formula (6): Z³—O-(A¹O)ₙ—CH{—CH₂-(A¹O)ₙ—Z³}₂,
wherein A¹O represents an oxyalkylene group of 2 to 6 carbon atoms, n represents the average addition molar number of A¹O, which is from 1 to 1,700, and Z³ represents a hydrogen atom or -A²-Z⁰, wherein A² represents an alkylene group of 2 to 6 carbon atoms, provided that at least one of the Z³ groups is -A²Z⁰. In all of formulae (4), (5) and (6), Z⁰ represents the alkoxysilyl group represented by formula (3). The oxyalkylene group for A¹O may be any of a straight chain and a branched chain, and in particular, it is preferably an oxypropylene group. The alkylene group for A² may be any of a straight chain and a branched chain, and in particular, it is preferably a propylene group.

One of the compounds represented by formula (5), which is preferably used, may be a compound represented by formula (5A):

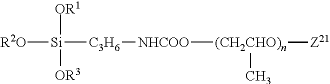

wherein R¹, R² and R³ each represent a monovalent hydrocarbon group of 1 to 6 carbon atoms and may be the same or different in the same molecule, n represents the average addition molar number of the oxypropylene groups, and Z²¹ represents a hydrogen atom or a trialkoxysilyl group represented by formula (5B):

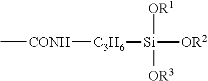

wherein R¹, R² and R³ have the same meanings as defined above.

In view of reworkability, the polyether compound (C2) preferably has a number average molecular weight of 300 to 100,000. The lower limit of the number average molecular weight is preferably 500 or more, more preferably 1,000 or more, even more preferably 2,000 or more, still more preferably 3,000 or more, further more preferably 4,000 or more, further more preferably 5,000 or more, and the upper limit of the number average molecular weight is preferably 50,000 or less, more preferably 40,000 or less, even more preferably 30,000 or less, still more preferably 20,000 or less, further more preferably 10,000 or less. Preferred ranges of the number average molecular weight may be set using the upper and lower limits. In the polyether compound (C2) represented by formula (3), (4), (5), or (6), n represents the average addition molar number of the oxyalkylene groups in the polyether skeleton. The polyether compound (C2) is preferably controlled so as to have a number average molecular weight in the above range. When the polyether compound (C2) has a number average molecular weight of 1,000 or more, n is generally from 10 to 1,700.

The Mw (the weight average molecular weight)/Mn (the number average molecular weight) ratio of the polymer is preferably 3.0 or less, more preferably 1.6 or less, particularly preferably 1.5 or less. In particular, an oxyalkylene polymer obtained by polymerizing a cyclic ether in the presence of an initiator and a catalyst of the composite metal cyanide complex shown below is preferably used to produce the reactive silyl group-containing polyether compound (C2) with a low Mw/Mn ratio, and a method of modifying the end of such an oxyalkylene polymer material into a reactive silyl group is most preferred.

For example, the polyether compound (C2) represented by formula (3), (4), (5), or (6) may be produced by a process including using an oxyalkylene polymer having a functional group at the molecular end as a raw material and linking a reactive silyl group to the molecular end through an organic group such as an alkylene group. The oxyalkylene polymer used as a raw material is preferably a hydroxyl-terminated polymer obtained by a ring-opening polymerization reaction of cyclic ether in the presence of a catalyst and an initiator.

The initiator to be used may be a compound having one or more active hydrogen atoms per molecule, such as a hydroxy compound having one or more hydroxyl groups in one molecule. For example, the initiator may be a hydroxyl group-containing compound such as ethylene glycol, propylene glycol, dipropylene glycol, butanediol, hexamethylene glycol, hydrogenated bisphenol A, neopentyl glycol, polybutadiene glycol, diethylene glycol, triethylene glycol, polyethylene glycol, allyl alcohol, methallyl alcohol, glycerin, trimethylolmethane, trimethylolpropane, pentaerythritol, or an alkylene oxide adduct of any of these compounds. The initiators may be used singly or in combination of two or more thereof.

A polymerization catalyst may be used in the ring-opening polymerization of cyclic ether in the presence of the initiator. Examples of the polymerization catalyst include alkali metal compounds such as potassium compounds such as potassium hydroxide and potassium methoxide and cesium compounds such as cesium hydroxide; composite metal cyanide complexes; metalloporphyrin complexes; and P═N bond-containing compounds.

In the polyether compound (C2) represented by formula (3), (4), (5), or (6), the polyoxyalkylene chain preferably comprises a polymerized unit of oxyalkylene formed by ring-opening polymerization of an alkylene oxide of 2 to 6 carbon atoms, preferably a repeating structural unit of an oxyalkylene group formed by ring-opening polymerization of at least one alkylene oxide selected from the group consisting of ethylene oxide, propylene oxide and butylene oxide, particularly preferably a repeating structural unit of oxyalkylene formed by ring-opening polymerization of propylene oxide. When the polyoxyalkylene chain comprises two or more oxyalkylene group repeating structural units, the two or more oxyalkylene group repeating structural units may be arranged in a block or random manner.

For example, the polyether compound represented by formula (5) may be obtained by a urethane forming reaction between a polymer having a polyoxyalkylene chain and a hydroxyl group and a compound having the reactive silyl group represented by formula (1) and an isocyanate group. An alternative method may also be used in which the reactive silyl group represented by formula (1) is introduced to the molecular end using an addition reaction of hydrosilane or mercaptosilane to the unsaturated group of an unsaturated group-containing oxyalkylene polymer such as an allyl-terminated polyoxypropylene monool obtained by polymerizing alkylene oxide with allyl alcohol as an initiator.

Examples of the method of introducing the reactive silyl group represented by formula (1) to the end group of a hydroxyl-terminated oxyalkylene polymer (also referred to as “oxyalkylene polymer material”) obtained by ring-opening polymerization of a cyclic ether in the presence of an initiator preferably include, but are not limited to, the methods (a), (b) and (c) described below in which the reactive silyl group is generally linked to the end group through an additional organic group.

(a) A method including introducing an unsaturated group to the end of an oxyalkylene polymer material having a hydroxyl group and then linking the reactive silyl group to the unsaturated group. Examples of this method may include the two methods (a-1) and (a-2) described below. (a-1) A method of allowing a hydrosilyl compound to react with the unsaturated group in the presence of a catalyst such as a platinum compound (a method using the so-called hydrosilylation reaction). (a-2) A method of allowing a mercaptosilane compound to react with the unsaturated group. Examples of the mercaptosilane compound include 3-mercaptopropyltrimethoxysilane, 3-mercaptopropyltriethoxysilane, 3-mercaptopropyltriisopropenyloxysilane, 3-mercaptopropylmethyldimethoxysilane, 3-mercaptopropyldimethylmonomethoxysilane, and 3-mercaptopropylmethyldiethoxysilane.

The reaction between the unsaturated group and the mercapto group may be performed using such a compound as a radical generator used as a radical polymerization initiator, or if desired, using radiation or heat with no radical polymerization initiator. Examples of the radical polymerization initiator include peroxide-type, azo-type and redox-type polymerization initiators, and metal compound catalysts, and specific examples thereof include 2,2′-azobisisobutyronitrile, 2,2′-azobis-2-methylbutyronitrile, benzoyl peroxide, tert-alkyl peroxyester, acetyl peroxide, and diisopropyl peroxycarbonate. The reaction between the unsaturated group and the mercapto group in the presence of a radical polymerization initiator is preferably performed for several hours to several tens of hours at a reaction temperature of generally 20 to 200° C., preferably 50 to 150° C., depending on the decomposition temperature (half-life temperature) of the polymerization initiator.

A method for introducing an unsaturated group to the end of the oxyalkylene polymer material may include allowing the oxyalkylene polymer material to react with a reactant having both an unsaturated group and a functional group capable of forming a bond, such as an ether bond, an ester bond, a urethane bond, or a carbonate bond, to the terminal hydroxyl group of the oxyalkylene polymer material. An alternative method may also be used in which an unsaturated group-containing epoxy compound such as allyl glycidyl ether is copolymerized in the process of polymerizing a cyclic ether in the presence of an initiator, so that the unsaturated group is introduced to at least part of the ends of the oxyalkylene polymer material. The method is preferably performed at a temperature of 60 to 120° C. In general, the hydrosilylation reaction can sufficiently proceed in a reaction time of several hours or less.

(b) A method of allowing the oxyalkylene polymer material having a hydroxyl group at the end to react with an isocyanate silane compound having a reactive silyl group. Examples of such an isocyanate silane compound include 1-isocyanatomethyltrimethoxysilane, 1-isocyanatomethyltriethoxysilane, 1-isocyanatopropyltrimethoxysilane, 1-isocyanatopropyltriethoxysilane, 3-isocyanatopropyltrimethoxysilane, 3-isocyanatopropyltriethoxysilane, 1-isocyanatomethylmethyldimethoxysilane, 1-isocyanatomethyldimethylmonomethoxysilane, 1-isocyanatomethylmethyldiethoxysilane, 1-isocyanatopropylmethyldimethoxysilane, 1-isocyanatopropyldimethylmonomethoxysilane, 1-isocyanatopropylmethyldiethoxysilane, 3-isocyanatopropylmethyldimethoxysi lane, 3-isocyanatopropyldimethylmonomethoxysilane, and 3-isocyanatopropylmethyldiethoxysilane. Among these compounds, 3-isocyanatopropyltrimethoxysilane and 1-isocyanatomethylmethyldimethoxysilane are more preferred, and 3-isocyanatopropyltrimethoxysilane is particularly preferred.

The reaction is preferably performed at a molar ratio (NCO/OH) of the isocyanate group (NCO) of the isocyanate silane compound to the hydroxyl group (OH) of the oxyalkylene polymer material of 0.80 to 1.05. This method has a small number of production steps and therefore makes it possible to significantly reduce the process time. This method produces no by-product impurities during the process and therefore does not need a complicated operation such as purification. The ratio (NCO/OH (molar ratio)) of the NCO group to the OH group is more preferably from 0.85 to 1.00. If the NCO ratio is too low, the remaining OH group may react with the reactive silyl group, so that the storage stability may be undesirable. In such a case, it is preferred that the isocyanate silane compound or a monoisocyanate compound should be newly allowed to react so that the excessive part of the OH groups can be consumed and that the silylation rate can be adjusted to the desired level.

A known urethane-forming reaction catalyst may also be used in the reaction between the hydroxyl group of the oxyalkylene polymer material and the isocyanate silane compound. While the reaction temperature and the reaction time required until the reaction is completed vary with the presence or absence and the amount of the urethane-forming reaction catalyst, the reaction is preferably performed at a temperature of generally 20 to 200° C., preferably 50 to 150° C. for several hours.

(c) A method including allowing the oxyalkylene polymer having a hydroxyl group at the molecular end to react with a polyisocyanate compound under isocyanate group-excess conditions to produce an oxyalkylene polymer having an isocyanate group in at least part of the ends and further allowing the isocyanate group to react with a functional group-containing silicon compound. The functional group of the silicon compound is an active hydrogen-containing group selected from the group consisting of a hydroxyl group, a carboxyl group, a mercapto group, a primary amino group, and a secondary amino group. Examples of the silicon compound include aminosilane compounds such as N-phenyl-3-aminopropyltrimethoxysilane, 3-aminopropyltrimethoxysilane, 3-aminopropyltriethoxysilane, N-phenyl-3-aminopropylmethyldimethoxysilane, 3-aminopropylmethyldimethoxysilane, and 3-aminopropylmethyldiethoxysilane; and mercaptosilane compounds such as 3-mercaptopropyltrimethoxysilane and 3-mercaptopropylmethyldimethoxysilane. A known urethane-forming reaction catalyst may also be used in the reaction of the hydroxyl group of the oxyalkylene polymer material having and the polyisocyanate compound, and in the reaction of the isocyanate group and the functional group-containing silicon compound. While the reaction temperature and the reaction time required until the reaction is completed vary with the presence or absence and the amount of the urethane-forming reaction catalyst, the reaction is preferably performed at a temperature of generally 20 to 200° C., preferably 50 to 150° C. for several hours.

Specific examples of the polyether compound (C2) include MS Polymers 5203, 5303 and 5810 manufactured by Kaneka Corporation; SILYL EST250 and EST280 manufactured by Kaneka Corporation; SAT100, SAT200, SAT220, SAT350, and SAT400 manufactured by Kaneka Corporation; and EXCESTAR 52410, 52420 or 53430 manufacture by ASAHI GLASS CO., LTD.

A single type of the polyether compound (C2) may be used alone, or a mixture of two or more types of the polymer compounds (C2) may be used. The total content of the polyether compound(s) (C2) is preferably from 0.001 to 20 parts by weight, based on 100 parts by weight of the (meth)acrylic polymer (A). The content of the polyether compound (C2) is preferably 0.01 parts by weight or more, more preferably 0.02 parts by weight or more, even more preferably 0.1 parts by weight or more, still more preferably 0.5 parts by weight or more, so that the reworkability can be improved. If the content of the polyether compound (C2) is more than 20 parts by weight, the humidity resistance may be insufficient, so that peeling may easily occur in a reliability test or the like. The content of the polyether compound (C2) is preferably 10 parts by weight or less, more preferably 5 parts by weight or less, even more preferably 3 parts by weight or less.

The pressure-sensitive adhesive composition of the present invention may also contain any other known additive. For example, a tackifier, a powder such as a colorant and a pigment, a dye, a surfactant, a plasticizer, a surface lubricant, a leveling agent, a softening agent, an antioxidant, an age resister, a light stabilizer, an ultraviolet absorbing agent, a polymerization inhibitor, an inorganic or organic filler, a metal powder, or a particle- or foil-shaped material may be added as appropriate depending on the intended use. A redox system including an added reducing agent may also be used in the controllable range.

The pressure-sensitive adhesive composition is used to form a pressure-sensitive adhesive layer. To form the pressure-sensitive adhesive layer, it is preferred that the total amount of the addition of the crosslinking agent should be controlled and that the effect of the crosslinking temperature and the crosslinking time should be carefully taken into account.

The crosslinking temperature and the crosslinking time may be controlled depending on the crosslinking agent used. The crosslinking temperature is preferably 170° C. or less.

The crosslinking process may be performed at the temperature of the process of drying the pressure-sensitive adhesive layer, or the crosslinking process may be separately performed after the drying process.

The crosslinking time is generally from about 0.2 to about 20 minutes, preferably from about 0.5 to about 10 minutes, while it may be set taking into account productivity and workability.

In an embodiment of the present invention, the pressure-sensitive adhesive optical member such as the pressure-sensitive adhesive optical film includes an optical film and a pressure-sensitive adhesive layer that is formed on at least one side of the optical film and produced with the pressure-sensitive adhesive.

For example, the pressure-sensitive adhesive layer may be formed by a method including applying the pressure-sensitive adhesive composition to a release-treated separator or the like, removing the polymerization solvent and so on by drying to form a pressure-sensitive adhesive layer and then transferring it to an optical film, or by a method including applying the pressure-sensitive adhesive composition to an optical film and removing the polymerization solvent and so on by drying to form a pressure-sensitive adhesive layer on the optical film. Before the pressure-sensitive adhesive is applied, in addition at least one solvent other than the polymerization solvent may be added to the pressure-sensitive adhesive.

A silicone release liner is preferably used as the release-treated separator. The pressure-sensitive adhesive composition of the present invention may be applied to such a liner and dried to form a pressure-sensitive adhesive layer. In this process, the pressure-sensitive adhesive may be dried using any appropriate method depending on the purpose. A method of drying by heating the coating film is preferably used. The heat drying temperature is preferably from 40° C. to 200° C., more preferably from 50° C. to 180° C., particularly preferably from 70° C. to 170° C. When the heating temperature is set in the above range, a pressure-sensitive adhesive having good adhesive properties can be obtained.

Any appropriate drying time may be used. The drying time is preferably from 5 seconds to 20 minutes, more preferably from 5 seconds to 10 minutes, particularly preferably from 10 seconds to 5 minutes.

An undercoat layer may also be formed on the surface of the optical film, before the pressure-sensitive adhesive layer is formed. The surface of the optical film may be subjected to any of various adhesion-facilitating treatments such as a corona treatment and a plasma treatment, which may be followed by forming an undercoat layer and then forming the pressure-sensitive adhesive layer. Alternatively, the surface of the optical film may be subjected to any of various adhesion-facilitating treatments such as a corona treatment and a plasma treatment, and then the pressure-sensitive adhesive layer may be formed directly on the treated surface. The surface of the pressure-sensitive adhesive layer may also be subjected to an adhesion-facilitating treatment.

Preferred materials used to form the undercoat layer exhibit good adhesion to both the pressure-sensitive adhesive layer and the optical film (for example, a transparent protective film of a polarizing plate) and can form a coating film with high cohesive strength. Materials that have such properties and may be used include various polymers, metal oxide sols, silica sols, and so on. Among these materials, polymers are particularly preferred.

The polymers may be polyurethane resins, polyester resins, and polymers having an amino group in the molecule. The type of the polymers to be used may be any of a solvent-soluble type, a water-dispersible type and a water-soluble type. Examples include water-soluble polyurethane, water-soluble polyester, water-soluble polyamide, and water-dispersible resins (such as ethylene-vinyl acetate polymer emulsions and (meth)acrylic polymer emulsions). Examples of water-dispersible types that may be used include emulsions of various resins such as polyurethane, polyester and polyamide, which are prepared using an emulsifier; and self-emulsifying resins prepared by introducing a water-dispersible hydrophilic anionic, cationic or nonionic group into the resins. Ionic polymer complexes may also be used.

When an isocyanate compound-containing pressure-sensitive adhesive layer is formed, such polymers preferably have a functional group having reactivity with the isocyanate compound. Such polymers are preferably polymers having an amino group in the molecule. Polymers having a primary amino group at the end are preferably used, which can react with the isocyanate compound to produce strong adhesion.

Examples of polymers having an amino group in the molecule include polyethyleneimine polymers, polyallylamine polymers, polyvinylamine polymers, polyvinylpyridine polymers, polyvinylpyrrolidine polymers, and polymers containing an amino group-containing monomer such as dimethylaminoethyl acrylate. In particular, polyethyleneimine polymers are preferred. Any polyethyleneimine material having a polyethyleneimine structure may be used, examples of which include polyethyleneimine, ethyleneimine adducts and/or polyethyleneimine adducts of polyacrylates.

Various polyethyleneimines may be used without particular limitations. The weight average molecular weight of the polyethyleneimine is generally, but not limited to, from about 100 to about 1,000,000. Commercially available examples of polyethyleneimines include EPOMIN SP series (such as SP-003, SP006, SP012, SP018, SP103, SP110, and SP200) and EPOMIN P-1000 manufactured by NIPPON SHOKUBAI CO., LTD. In particular, EPOMIN P-1000 is preferred.

According to conventional methods, ethyleneimine adducts and/or polyethyleneimine adducts of polyacrylate esters may be obtained by emulsion polymerization of an alkyl (meth)acrylate, which is used to form a base polymer (acrylic polymer) of the acrylic pressure-sensitive adhesive described, and a monomer copolymerizable therewith. The copolymerizable monomer to be used may be a monomer having a functional group for reacting with ethyleneimine or the like, such as a carboxyl group. The content of the monomer having such a functional group as a carboxyl group may be appropriately adjusted depending on the content of the ethyleneimine or the like subjected to the reaction. A styrene type monomer is preferably used as the copolymerizable monomer. Alternatively, the carboxyl group or the like of an acrylic ester may be allowed to react with separately synthesized polyethyleneimine so that addition products having grafted polyethyleneimine moieties can be produced. Examples of commercially available products include POLYMENT NK-380 manufactured by NIPPON SHOKUBAI CO., LTD.

Ethyleneimine adducts and/or polyethyleneimine adducts of acrylic polymer emulsions may also be used. Examples of commercially available products include POLYMENT SK-1000 manufactured by NIPPON SHOKUBAI CO., LTD.

In the process of forming the undercoat layer, the amino group-containing polymer may be mixed with a compound capable of reacting with the amino group-containing polymer, so that the polymer can be crosslinked to increase the strength of the undercoat layer. For example, the compound capable of reacting with the amino group-containing polymer may be an epoxy compound or the like.

When the undercoat layer is provided, the formation of the undercoat layer on the optical film is followed by the formation of the pressure-sensitive adhesive layer. For example, an undercoating solution such as an aqueous polyethyleneimine solution is applied by a method of application, such as coating, dipping, or spraying, and then the coating is dried to form an undercoat layer. The thickness of the undercoat layer is preferably about from 10 to about 5,000 nm, more preferably from 50 to 500 nm. If the undercoat layer is too thin, it may fail to have properties as a bulk or fail to exhibit sufficient strength so that the resulting adhesion may be insufficient. If it is too thick, the optical properties may be degraded.

To impart electrical conductivity, an electrically-conductive polymer may also be added to the undercoat layer. Any of various electrically-conductive polymers may be used without particular limitations. Examples thereof include polyaniline, polythiophene, polyethyleneimine, and allylamine compounds. Polyaniline and/or polythiophene is preferably used.

Various methods may be used to form the pressure-sensitive adhesive layer. Specific examples of such methods include roll coating, kiss roll coating, gravure coating, reverse coating, roll brush coating, spray coating, dip roll coating, bar coating, knife coating, air knife coating, curtain coating, lip coating, and extrusion coating with a die coater or the like.

The thickness of the pressure-sensitive adhesive layer is typically, but not limited to, from about 1 to 100 μm, preferably from 2 to 50 μm, more preferably from 2 to 40 μm, further preferably from 5 to 35 μm.

When the pressure-sensitive adhesive layer is exposed, the pressure-sensitive adhesive layer may be protected with a sheet having undergone release treatment (a separator) before practical use.

Examples of the material for forming the separator include a plastic film such as a polyethylene, polypropylene, polyethylene terephthalate, or polyester film, a porous material such as paper, cloth and nonwoven fabric, and an appropriate thin material such as a net, a foamed sheet, a metal foil, and a laminate thereof. In particular, a plastic film is preferably used, because of its good surface smoothness.

The plastic film may be any film capable of protecting the pressure-sensitive adhesive layer, and examples thereof include a polyethylene film, a polypropylene film, a polybutene film, a polybutadiene film, a polymethylpentene film, a polyvinyl chloride film, a vinyl chloride copolymer film, a polyethylene terephthalate film, a polybutylene terephthalate film, a polyurethane film, and an ethylene-vinyl acetate copolymer film.

The thickness of the separator is generally from about 5 to about 200 μm, preferably from about 5 to about 100 μm. If necessary, the separator may be treated with a release agent such as a silicone, fluorine, long-chain alkyl, or fatty acid amide release agent, or may be subjected to release and antifouling treatment with silica powder or to antistatic treatment of coating type, kneading and mixing type, vapor-deposition type, or the like. In particular, if the surface of the separator is appropriately subjected to release treatment such as silicone treatment, long-chain alkyl treatment, and fluorine treatment, the releasability from the pressure-sensitive adhesive layer can be further increased.

In the above production method, the release-treated sheet may be used without modification as a separator for the pressure-sensitive adhesive sheet, the pressure-sensitive adhesive optical film or the like, so that the process can be simplified.

The optical film may be of any type for use in forming image displays such as liquid crystal displays. For example, a polarizing plate is exemplified as the optical film. A polarizing plate including a polarizer and a transparent protective film provided on one or both sides of the polarizer is generally used. Concerning optical films, for example, triacetylcellulose resins, (meth)acrylic resins, norbornene resins, or the like are used to form transparent protective films. The pressure-sensitive adhesive optical film of the present invention show good durability to these various materials.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. In these, a polyvinyl alcohol type film on which dichromatic materials such as iodine, is absorbed and aligned after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing un-uniformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

A thermoplastic resin with a high level of transparency, mechanical strength, thermal stability, moisture blocking properties, isotropy, and the like may be used as a material for forming the transparent protective film. Examples of such a thermoplastic resin include cellulose resins such as triacetylcellulose, polyester resins, polyethersulfone resins, polysulfone resins, polycarbonate resins, polyamide resins, polyimide resins, polyolefin resins, (meth)acrylic resins, cyclic olefin polymer resins (norbornene resins), polyarylate resins, polystyrene resins, polyvinyl alcohol resins, and any mixture thereof. The transparent protective film is generally laminated to one side of the polarizer with the adhesive layer, but thermosetting resins or ultraviolet curing resins such as (meth)acrylic, urethane, acrylic urethane, epoxy, or silicone resins may be used to other side of the polarizer for the transparent protective film. The transparent protective film may also contain at least one type of any appropriate additive. Examples of the additive include an ultraviolet absorbing agent, an antioxidant, a lubricant, a plasticizer, a release agent, an anti-discoloration agent, a flame retardant, a nucleating agent, an antistatic agent, a pigment, and a colorant. The content of the thermoplastic resin in the transparent protective film is preferably from 50 to 100% by weight, more preferably from 50 to 99% by weight, still more preferably from 60 to 98% by weight, particularly preferably from 70 to 97% by weight. If the content of the thermoplastic resin in the transparent protective film is 50% by weight or less, high transparency and other properties inherent in the thermoplastic resin can fail to be sufficiently exhibited.

Further an optical film of the present invention may be used as other optical layers, such as a reflective plate, a transflective plate, a retardation plate (a half wavelength plate and a quarter wavelength plate included), and a viewing angle compensation film, which may be used for formation of a liquid crystal display etc. These are used in practice as an optical film, or as one layer or two layers or more of optical layers laminated with polarizing plate.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as a pressure-sensitive adhesive layer, may be used for laminating. On the occasion of adhesion of the above described polarizing plate and other optical layers, the optical axis may be set as a suitable configuration angle according to the target retardation characteristics etc.

The pressure-sensitive adhesive optical film of the present invention is preferably used to form various types of image displays such as liquid crystal displays. Liquid crystal displays may be formed according to conventional techniques. Specifically, liquid crystal displays are generally formed by appropriately assembling a liquid crystal cell and the pressure-sensitive adhesive optical film and optionally other component such as a lighting system and incorporating a driving circuit according to any conventional technique, except that the pressure-sensitive adhesive optical film of the present invention is used. Any type of liquid crystal cell may also be used such as a TN type, an STN type, a n type a VA type and IPS type.

Suitable liquid crystal displays, such as liquid crystal display with which the pressure-sensitive adhesive optical film has been located at one side or both sides of the liquid crystal cell, and with which a backlight or a reflective plate is used for a lighting system may be manufactured. In this case, the optical film may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

### EXAMPLES

The present invention is more specifically described by the examples below, which are not intended to limit the scope of the present invention. In each example, parts and % are all by weight. Unless otherwise stated below, the conditions of room temperature standing are 23° C. and 65% RH in all the cases.

<Measurement of Weight Average Molecular Weight of (Meth)acrylic Polymer (A) and Mw/Mn>

The weight average molecular weight (Mw) of the (meth)acrylic polymer (A) was measured by GPC (Gel Permeation Chromatography). Mw/Mn was also measured in a similar manner.

Analyzer: HLC-8120GPC manufactured by TOSOH CORPORATION
Columns: G7000H_{XL}+GMH_{XL}+GMH_{XL} manufactured by TOSOH CORPORATION
Column size: each 7.8 mmφ×30 cm, 90 cm in total
Colum temperature: 40° C.
Flow rate: 0.8 ml/minute
Injection volume: 100 μl
Eluent: tetrahydrofuran
Detector: differential refractometer (RI)
Standard sample: polystyrene

<Measurement of Number Average Molecular Weight of Polyether compound (C2)>

The number average molecular weight of the polyether compound (C2) was measured by GPC (Gel Permeation Chromatography).

Analyzer: HLC-8120GPC manufactured by TOSOH CORPORATION
Column: TSK gel, Super HZM-H/HZ4000/HZ2000
Column size: 6.0 mm I.D.×150 mm
Colum temperature: 40° C.
Flow rate: 0.6 ml/minute
Injection volume: 20 μl
Eluent: tetrahydrofuran
Detector: differential refractometer (RI)
Standard sample: polystyrene

(Preparation of Polarizing Plate)

An 80 μm-thick polyvinyl alcohol film was stretched to 3 times between rolls different in velocity ratio, while it was dyed in a 0.3% iodine solution at 30° C. for 1 minute. The film was then stretched to a total draw ratio of 6 times, while it was immersed in an aqueous solution containing 4% of boric acid and 10% of potassium iodide at 60° C. for 0.5 minutes. The film was then washed by immersion in an aqueous solution containing 1.5% of potassium iodide at 30° C. for 10 seconds and then dried at 50° C. for 4 minutes to give a polarizer. Saponified triacetylcellulose films each with a thickness of 80 μm were bonded to both sides of the polarizer with a polyvinyl alcohol adhesive to form a polarizing plate. Polarizing plates were also prepared as described above, except that 30 μm-thick acrylic films (lactone-modified acrylic resin films) or 60 μm-thick norbornene polymer films (ZEONOR Film ZB12, manufactured by ZEON CORPORATION) were used in place of the 80 μm-thick triacetylcellulose films. The resulting three polarizing plates having different transparent protective films were used in the examples.

### Example 1

(Preparation of Acrylic Polymer (A))

To a four-neck flask equipped with a stirring blade, a thermometer, a nitrogen gas introducing tube, and a condenser were added 74.9 parts of butyl acrylate, 20 parts of benzyl acrylate, 5 parts of acrylic acid, 0.1 parts of 4-hydroxybutyl acrylate, 0.1 parts of 2,2′-azobisisobutyronitrile as a polymerization initiator, and 100 parts of ethyl acetate (at a monomer concentration of 50%). Nitrogen gas was introduced to replace the air, while the mixture was gently stirred, and then a polymerization reaction was performed for 8 hours, while the temperature of the liquid in the flask was kept at about 55° C., so that a solution of an acrylic polymer with a weight average molecular weight (Mw) of 2,040,000 and an Mw/Mn ratio of 3.2 was prepared.

(Preparation of Pressure-Sensitive Adhesive Composition)

Based on 100 parts of the solids of the resulting acrylic polymer solution, 0.45 parts of an isocyanate crosslinking agent (tolylene diisocyanate adduct of trimethylolpropane, Coronate L manufactured by Nippon Polyurethane Industry Co., Ltd.), 0.1 parts of benzoyl peroxide (Nyper BMT manufactured by NOF Corporation) and 0.1 parts of a silane coupling agent (KBM403 manufactured by Shin-Etsu Chemical Co., Ltd.) were added to the acrylic polymer solution, so that a solution (11% in solids content) of an acrylic pressure-sensitive adhesive composition was prepared.

(Formation of Pressure-Sensitive Adhesive Layer)

The acrylic pressure-sensitive adhesive solution was then applied to one side of a silicone-treated, 38 μm-thick, polyethylene terephthalate (PET) film (MRF38 manufactured by Mitsubishi Polyester Film Corporation) so that a 23 μm-thick pressure-sensitive adhesive layer could be formed after drying. The acrylic pressure-sensitive adhesive solution was then dried at 155° C. for 1 minute to form a pressure-sensitive adhesive layer.

(Preparation of Pressure-Sensitive Adhesive Layer-Carrying Polarizing Plate)

An undercoat layer (100 nm in thickness) was formed by applying, with a wire bar, an undercoating agent to the transparent protective film side of each of the three polarizing plates, where a pressure-sensitive adhesive layer was to be formed. The undercoating agent used was prepared by diluting a thiophene polymer-containing solution (Denatron P521-AC (trade name) manufactured by Nagase ChemteX Corporation) with a mixture solution of water and isopropyl alcohol so that a solids content of 0.6% by weight could be obtained. Each of the pressure-sensitive adhesive layers was then transferred from the silicone-treated PET film to the undercoat layer, so that three pressure-sensitive adhesive layer-carrying polarizing plates were obtained.

### Examples 2 to 28 and Comparative Examples 1 to 9

Acrylic polymer solutions and solutions of acrylic pressure-sensitive adhesive compositions were prepared as in Example 1, except that the type of monomers used in the preparation of the acrylic polymer (A), the content of the monomers, the polymer properties (weight average molecular weight, Mw/Mn), the type or content of the crosslinking agent (B), and the type, content, or presence or absence of the silyl group-containing compound (C) were changed as shown in Table 1 and that the concentration of the monomers and the reaction conditions of the polymerization time in the preparation of the acrylic polymer (A) were changed as shown in Table 1. Pressure-sensitive adhesive layer-carrying polarizing plates were also prepared using the solutions of the acrylic pressure-sensitive adhesive compositions.

The three pressure-sensitive adhesive layer-carrying polarizing plates (samples) obtained in the examples and the comparative examples were evaluated as described below. The results of the evaluation are shown in Table 1.

<Corner Non-Uniformity>

Two pieces with a size of 420 mm (length)×320 mm (width) were prepared by cutting each sample. The samples were bonded with a laminator to both sides of a 0.07 mm-thick non-alkali glass plate in the crossed Nicols arrangement. The sample laminate was then autoclaved at 50° C. under 5 atm for 15 minutes to give a secondary sample (initial stage). The secondary sample was then treated under the condition of 90° C. for 24 hours (after heating). At the initial stage and after heating, the secondary sample was placed on a 10,000 candela backlight, and light leakage was visually evaluated according to the criteria below.

⊙: There is neither corner non-uniformity nor practical problem.
ο: Corner non-uniformity slightly occurs but does not occur in the display region, and therefore, there is no practical problem.
Δ: Corner non-uniformity slightly occurs in the display region, but there is no practical problem.
×: Corner non-uniformity significantly occurs in the display region to cause a practical problem.

<Durability>

The sample was formed with a size of 37 inches and bonded to a 0.7 mm-thick non-alkali glass plate (1737 manufactured by Corning Incorporated) using a laminator. The sample was then autoclaved at 50° C. under 0.5 MPa for 15 minutes, so that it was completely bonded to the non-alkali glass plate. The autoclaved sample was heat-treated at 80° C. for 500 hours (heating test 1) or at 100° C. for 500 hours (heating test 2) or humidity-treated under an atmosphere at 60° C. and 90% RH for 500 hours (humidifying test) and then subjected to 300 cycles of one hour in 85° C. and −40° C. environments (heat shock test).

Thereafter, the appearance between the polarizing plate and the glass plate was visually evaluated according to the criteria below.

⊙: There is no change in the appearance, such as foaming, peeling or separation.
ο: Peeling or foaming is slightly observed at an end portion, but there is no practical problem.
Δ: Peeling or foaming is observed at an end portion, but there is no practical problem if the intended use is not special.
×: Remarkable peeling is observed at an end portion to cause a practical problem.

<Reworkability>

The sample was cut into a piece of 25 mm (width)×100 mm (length), which was bonded to a 0.7 mm-thick non-alkali glass plate (1737 manufactured by Corning Incorporated) using a laminator. The sample was then autoclaved at 50° C. under 5 atm for 15 minutes, so that it was completely bonded to the glass plate (initial stage). Thereafter, the sample was heat-treated at 60° C. under dry conditions for 48 hours (after heating), and then, the adhesive strength of the sample piece was measured.

The sample was peeled from the glass plate at a peel angle of 90° and a peel rate of 300 mm/minute with a tensile tester (Autograph SHIMAZU AG-1 10KN), when the adhesive strength (N/25 mm, 80 m in length during the measurement) was measured. In the measurement, sampling was performed at an interval of 0.5 seconds for one measurement, and the average was used as the measured value.

TABLE 1

| | | | | | | | | | | | | | Silyl group- | | | | |
|---|---|---|---|---|---|---|---|---|---|---|---|---|---|---|---|---|---|
| | Acrylic polymer | | | | | | | | | Crosslinking | | | containing | | | | |
| | (A) | | | | | | | | | agent (B) Type and | | | compound (C) Type and | | | | |
| | Monomer | | | | | Polymerization | | | | added amount | | | added amount | | Corner non- | | |
| | components | | | | | conditions | | | | (parts by | | | (parts by | | uniformity | | |
| | (wt %) | | | | | Monomer | | Polymer | | weight) | | | weight) | | Initial stage | | |
| | (a1) | (a2) | (a3) | (a4) | | concentration | | properties | | type | Peroxide type | Epoxy type | coupling agent | compound (C2) | TAC | Acrylic | Norbornene |
| | BA | BzA | AA | HBA | HEA | (%) | (hours) | Mw | Mw/Mn | amount | amount | amount | amount | amount | type | type | type |
| Example 1 | 74.9 | 20.0 | 5.0 | 0.1 | — | 50.0 | 8.0 | 2,040,000 | 3.2 | 0.45 | 0.1 | — | 0.1 | — | ⊙ | ⊙ | ⊙ |
| Example 2 | 76.9 | 18.0 | 5.0 | 0.1 | — | 50.0 | 8.0 | 2,000,000 | 3.1 | 0.45 | 0.1 | — | 0.1 | — | ⊙ | ⊙ | ⊙ |
| Example 3 | 78.9 | 16.0 | 5.0 | 0.1 | — | 50.0 | 8.0 | 2,030,000 | 2.7 | 0.45 | 0.1 | — | 0.1 | — | ⊙ | ⊙ | ⊙ |
| Example 4 | 81.9 | 13.0 | 5.0 | 0.1 | — | 50.0 | 8.0 | 2,000,000 | 2.7 | 0.45 | 0.1 | — | 0.1 | — | ⊙ | ⊙ | ⊙ |
| Example 5 | 84.9 | 10.0 | 5.0 | 0.1 | — | 50.0 | 8.0 | 2,030,000 | 2.9 | 0.45 | 0.1 | — | 0.1 | — | ⊙ | ⊙ | ⊙ |
| Example 6 | 87.9 | 7.0 | 5.0 | 0.1 | — | 50.0 | 8.0 | 2,030,000 | 2.8 | 0.45 | 0.1 | — | 0.1 | — | ⊙ | ⊙ | ⊙ |
| Example 7 | 90.9 | 4.0 | 5.0 | 0.1 | — | 50.0 | 8.0 | 2,020,000 | 2.9 | 0.45 | 0.1 | — | 0.1 | — | ⊙ | ⊙ | ⊙ |
| Example 8 | 93.9 | 1.0 | 5.0 | 0.1 | — | 50.0 | 8.0 | 2,000,000 | 2.8 | 0.45 | 0.1 | — | 0.1 | — | ⊙ | ⊙ | ⊙ |
| Example 9 | 84.4 | 13.0 | 4.0 | 0.1 | — | 50.0 | 8.0 | 2,000,000 | 3.0 | 0.45 | 0.1 | — | 0.1 | — | ⊙ | ⊙ | ⊙ |
| Example 10 | 76.9 | 13.0 | 10.0 | 0.1 | — | 50.0 | 8.0 | 1,960,000 | 3.0 | 0.45 | 0.1 | — | 0.1 | — | ⊙ | ⊙ | ⊙ |
| Example 11 | 79.4 | 13.0 | 7.5 | 0.1 | — | 50.0 | 8.0 | 1,980,000 | 2.8 | 0.45 | 0.1 | — | 0.1 | — | ⊙ | ⊙ | ⊙ |
| Example 12 | 81.9 | 13.0 | 5.0 | — | 0.1 | 50.0 | 8.0 | 2,020,000 | 2.8 | 0.45 | 0.1 | — | 0.1 | — | ⊙ | ⊙ | ⊙ |
| Example 13 | 81.3 | 13.0 | 5.0 | 0.7 | | 50.0 | 8.0 | 2,000,000 | 2.7 | 0.45 | 0.1 | — | 0.1 | — | ⊙ | ⊙ | ⊙ |
| Example 14 | 80.5 | 13.0 | 5.0 | 1.5 | — | 50.0 | 8.0 | 2,000,000 | 3.2 | 0.45 | 0.1 | — | 0.1 | — | ⊙ | ⊙ | ⊙ |
| Example 15 | 81.9 | 13.0 | 5.0 | 0.1 | — | 40.0 | 8.0 | 1,620,000 | 2.7 | 0.45 | 0.1 | — | 0.1 | — | ⊙ | ⊙ | ⊙ |
| Example 16 | 81.9 | 13.0 | 5.0 | 0.1 | — | 45.0 | 8.0 | 1,780,000 | 2.9 | 0.45 | 0.1 | — | 0.1 | — | ⊙ | ⊙ | ⊙ |
| Example 17 | 81.9 | 13.0 | 5.0 | 0.1 | — | 54.0 | 8.0 | 2,400,000 | 2.9 | 0.45 | 0.1 | — | 0.1 | — | ⊙ | ⊙ | ⊙ |
| Example 18 | 81.9 | 13.0 | 5.0 | 0.1 | — | 58.0 | 8.0 | 2,750,000 | 3.1 | 0.45 | 0.1 | — | 0.1 | — | ⊙ | ⊙ | ⊙ |
| Example 19 | 81.9 | 13.0 | 5.0 | 0.1 | — | 62.0 | 8.0 | 2,900,000 | 3.1 | 0.45 | 0.1 | — | 0.1 | — | ⊙ | ⊙ | ⊙ |
| Example 20 | 81.9 | 13.0 | 5.0 | 0.1 | — | 66.0 | 8.0 | 3,100,000 | 3.0 | 0.45 | 0.1 | — | 0.1 | — | ⊙ | ⊙ | ⊙ |
| Example 21 | 81.9 | 13.0 | 5.0 | 0.1 | — | 50.0 | 5.0 | 2,000,000 | 1.9 | 0.45 | 0.1 | — | 0.1 | — | ⊙ | ⊙ | ⊙ |
| Example 22 | 81.9 | 13.0 | 5.0 | 0.1 | — | 50.0 | 10.0 | 2,020,000 | 5.7 | 0.45 | 0.1 | — | 0.1 | — | ⊙ | ⊙ | ⊙ |
| Example 23 | 81.9 | 13.0 | 5.0 | 0.1 | — | 50.0 | 13.0 | 2,070,000 | 9.6 | 0.45 | 0.1 | — | 0.1 | — | ⊙ | ⊙ | ⊙ |
| Example 24 | 81.9 | 13.0 | 5.0 | 0.1 | — | 50.0 | 8.0 | 2,020,000 | 2.9 | 0.45 | 0.1 | — | — | — | ⊙ | ⊙ | ⊙ |
| Example 25 | 81.9 | 13.0 | 5.0 | 0.1 | — | 50.0 | 8.0 | 2,010,000 | 2.9 | 0.45 | 0.1 | — | — | 1 | ⊙ | ⊙ | ⊙ |
| Example 26 | 81.9 | 13.0 | 5.0 | 0.1 | — | 50.0 | 8.0 | 2,010,000 | 3.0 | 0.65 | — | — | 0.1 | — | ⊙ | ⊙ | ⊙ |
| Example 27 | 81.9 | 13.0 | 5.0 | 0.1 | — | 50.0 | 8.0 | 2,020,000 | 3.0 | — | — | 0.2 | — | — | ⊙ | ⊙ | ⊙ |
| Example 28 | 81.9 | 13.0 | 5.0 | 0.1 | — | 50.0 | 8.0 | 2,000,000 | 3.0 | 0.3 | 0.1 | — | 0.1 | — | ⊙ | ⊙ | ⊙ |
| Comparative | 59.9 | 35.0 | 5.0 | 0.1 | — | 50.0 | 8.0 | 1,970,000 | 2.7 | 0.45 | 0.1 | — | — | — | ⊙ | ⊙ | ⊙ |
| Example 1 | | | | | | | | | | | | | | | | | |
| Comparative | 94.9 | — | 5.0 | 0.1 | — | 50.0 | 8.0 | 2,020,000 | 2.9 | 0.45 | 0.1 | — | — | — | ⊙ | ⊙ | ⊙ |
| Example 2 | | | | | | | | | | | | | | | | | |
| Comparative | 85.9 | 13.0 | 1.0 | 0.1 | — | 50.0 | 8.0 | 2,070,000 | 3.0 | 0.45 | 0.1 | — | — | — | ⊙ | ⊙ | ⊙ |
| Example 3 | | | | | | | | | | | | | | | | | |
| Comparative | 81.9 | 13.0 | 5.0 | 0.1 | — | 36.0 | 8.0 | 1,400,000 | 2.9 | 0.45 | 0.1 | — | 0.1 | — | ⊙ | ⊙ | ⊙ |
| Example 4 | | | | | | | | | | | | | | | | | |
| Comparative | 81.9 | 13.0 | 5.0 | 0.1 | — | 50.0 | 15.0 | 2,020,000 | 12.1 | 0.45 | 0.1 | — | 0.1 | — | ⊙ | ⊙ | ⊙ |
| Example 5 | | | | | | | | | | | | | | | | | |
| Comparative | 82.0 | 13.0 | 5.0 | — | — | 50.0 | 8.0 | 2,010,000 | 2.8 | 0.45 | 0.1 | — | 0.1 | — | ⊙ | ⊙ | ⊙ |
| Example 6 | | | | | | | | | | | | | | | | | |
| Comparative | 78.0 | 13.0 | 5.0 | 4.0 | — | 50.0 | 8.0 | 2,000,000 | 2.9 | 0.45 | 0.1 | — | 0.1 | — | ⊙ | ⊙ | ⊙ |
| Example 7 | | | | | | | | | | | | | | | | | |
| Comparative | 86.9 | 13.0 | — | 0.1 | — | 50.0 | 8.0 | 2,000,000 | 3.0 | 0.45 | 0.1 | — | 0.1 | — | ⊙ | ⊙ | ⊙ |
| Example 8 | | | | | | | | | | | | | | | | | |
| Comparative | 74.9 | 13.0 | 12.0 | 0.1 | — | 50.0 | 8.0 | 2,020,000 | 2.9 | 0.45 | 0.1 | — | 0.1 | — | ⊙ | ⊙ | ⊙ |
| Example 9 | | | | | | | | | | | | | | | | | |

| | Corner non- | | | | | | | | | | | | | | | Reworkability | |
|---|---|---|---|---|---|---|---|---|---|---|---|---|---|---|---|---|---|
| | uniformity | | | Durability | | | | | | | | | | | | strength | |
| | After heating | | | TAC type | | | | Acrylic type | | | | Norbornene type | | | | (N/25 mm) | |
| | TAC | Acrylic | Norbornene | Heating | Heating | Humidifying | Heat | Heating | Heating | Humidifying | Heat | Heating | Heating | Humidifying | Heat | Initial | After |
| | type | type | type | test 1 | test 2 | test | shock test | test 1 | test 2 | test | shock test | test 1 | test 2 | test | shock test | stage | heating |
| Example 1 | ◯ | ◯ | ⊙ | ⊙ | ⊙ | ⊙ | ⊙ | ⊙ | ⊙ | ⊙ | ⊙ | ⊙ | ◯ | ⊙ | ⊙ | 10.2 | 18.4 |
| Example 2 | ◯ | ⊙ | ⊙ | ⊙ | ⊙ | ⊙ | ⊙ | ⊙ | ⊙ | ⊙ | ⊙ | ⊙ | ◯ | ⊙ | ⊙ | 10.2 | 18.2 |
| Example 3 | ⊙ | ⊙ | ⊙ | ⊙ | ⊙ | ⊙ | ⊙ | ⊙ | ⊙ | ⊙ | ⊙ | ⊙ | ◯ | ⊙ | ⊙ | 10.3 | 19.2 |
| Example 4 | ⊙ | ⊙ | ⊙ | ⊙ | ⊙ | ⊙ | ⊙ | ⊙ | ⊙ | ⊙ | ⊙ | ⊙ | ◯ | ⊙ | ⊙ | 10 | 18.2 |
| Example 5 | ⊙ | ⊙ | ⊙ | ⊙ | ⊙ | ⊙ | ⊙ | ⊙ | ⊙ | ⊙ | ⊙ | ⊙ | ◯ | ⊙ | ⊙ | 10.4 | 18.5 |
| Example 6 | ⊙ | ◯ | ⊙ | ⊙ | ⊙ | ⊙ | ⊙ | ⊙ | ⊙ | ⊙ | ⊙ | ⊙ | ◯ | ⊙ | ⊙ | 10.2 | 19.2 |
| Example 7 | ⊙ | ◯ | ◯ | ⊙ | ⊙ | ⊙ | ⊙ | ⊙ | ⊙ | ⊙ | ⊙ | ⊙ | ◯ | ⊙ | ⊙ | 10 | 18.4 |
| Example 8 | ⊙ | Δ | ◯ | ⊙ | ⊙ | ⊙ | ⊙ | ⊙ | ⊙ | ⊙ | ⊙ | ⊙ | ◯ | ⊙ | ⊙ | 10.2 | 19 |
| Example 9 | ⊙ | ⊙ | ⊙ | ⊙ | ⊙ | ⊙ | ⊙ | ⊙ | ◯ | ◯ | ⊙ | ◯ | ◯ | ◯ | ◯ | 9.2 | 16.2 |
| Example 10 | ⊙ | ⊙ | ⊙ | ⊙ | ⊙ | ⊙ | ⊙ | ⊙ | ⊙ | ⊙ | ⊙ | ⊙ | ◯ | ⊙ | ⊙ | 12.8 | 21.2 |
| Example 11 | ⊙ | ⊙ | ⊙ | ⊙ | ⊙ | ⊙ | ⊙ | ⊙ | ⊙ | ⊙ | ⊙ | ⊙ | ◯ | ⊙ | ⊙ | 11.4 | 20.2 |
| Example 12 | ⊙ | ⊙ | ⊙ | ⊙ | ⊙ | ⊙ | ⊙ | ⊙ | ◯ | ◯ | ⊙ | ⊙ | ◯ | ◯ | ◯ | 10.2 | 18.6 |
| Example 13 | ⊙ | ⊙ | ⊙ | ⊙ | ◯ | ◯ | ⊙ | ⊙ | ◯ | ◯ | ⊙ | ⊙ | ◯ | ◯ | ◯ | 10.2 | 18.7 |
| Example 14 | ⊙ | ⊙ | ⊙ | ⊙ | ◯ | ◯ | ◯ | ◯ | ◯ | ◯ | ◯ | ⊙ | ◯ | ◯ | ◯ | 10.4 | 18.2 |
| Example 15 | ⊙ | ⊙ | ⊙ | ⊙ | ◯ | ◯ | ◯ | ◯ | ◯ | ◯ | ◯ | ⊙ | ◯ | ◯ | ◯ | 10.5 | 18.6 |
| Example 16 | ⊙ | ⊙ | ⊙ | ⊙ | ⊙ | ⊙ | ⊙ | ⊙ | ◯ | ⊙ | ⊙ | ⊙ | ◯ | ◯ | ◯ | 10.2 | 18.2 |
| Example 17 | ⊙ | ⊙ | ⊙ | ⊙ | ⊙ | ⊙ | ⊙ | ⊙ | ⊙ | ⊙ | ⊙ | ⊙ | ◯ | ⊙ | ⊙ | 10.5 | 18.2 |
| Example 18 | ⊙ | ⊙ | ⊙ | ⊙ | ⊙ | ⊙ | ⊙ | ⊙ | ⊙ | ⊙ | ⊙ | ⊙ | ◯ | ⊙ | ⊙ | 10.5 | 18.2 |
| Example 19 | ⊙ | ⊙ | ⊙ | ⊙ | ⊙ | ⊙ | ⊙ | ⊙ | ⊙ | ⊙ | ⊙ | ⊙ | ◯ | ◯ | ◯ | 10.4 | 18.5 |
| Example 20 | ⊙ | ⊙ | ⊙ | ⊙ | ◯ | ⊙ | ⊙ | ⊙ | ◯ | ⊙ | ⊙ | ⊙ | ◯ | ◯ | ◯ | 10.5 | 18.5 |
| Example 21 | ⊙ | ⊙ | ⊙ | ⊙ | ⊙ | ⊙ | ⊙ | ⊙ | ◯ | ⊙ | ⊙ | ⊙ | ◯ | ⊙ | ⊙ | 10.1 | 19.2 |
| Example 22 | ⊙ | ⊙ | ⊙ | ⊙ | ⊙ | ⊙ | ⊙ | ⊙ | ◯ | ⊙ | ⊙ | ⊙ | ◯ | ⊙ | ⊙ | 10 | 18.2 |
| Example 23 | ⊙ | ⊙ | ⊙ | ⊙ | ◯ | ⊙ | ⊙ | ⊙ | ◯ | ⊙ | ⊙ | ⊙ | ◯ | ◯ | ◯ | 10.6 | 18 |
| Example 24 | ⊙ | ⊙ | ⊙ | ⊙ | ◯ | ◯ | ⊙ | ⊙ | ◯ | ◯ | ⊙ | ⊙ | ◯ | ◯ | ⊙ | 9.2 | 16 |
| Example 25 | ⊙ | ⊙ | ⊙ | ⊙ | ⊙ | ⊙ | ⊙ | ⊙ | ⊙ | ⊙ | ⊙ | ⊙ | ◯ | ⊙ | ⊙ | 5.6 | 6.8 |
| Example 26 | ⊙ | ⊙ | ⊙ | ⊙ | ⊙ | ⊙ | ⊙ | ⊙ | ⊙ | ⊙ | ⊙ | ⊙ | ◯ | ⊙ | ⊙ | 10.4 | 18.6 |
| Example 27 | ⊙ | ⊙ | ⊙ | ⊙ | ⊙ | ⊙ | ⊙ | ⊙ | ⊙ | ⊙ | ⊙ | ⊙ | ◯ | ⊙ | ⊙ | 10.6 | 18.2 |
| Example 28 | ⊙ | ⊙ | ⊙ | ⊙ | ⊙ | ⊙ | ⊙ | ⊙ | ⊙ | ⊙ | ⊙ | ⊙ | ◯ | ⊙ | ⊙ | 10.7 | 18.1 |
| Comparative | Δ | Δ | Δ | ⊙ | ⊙ | ⊙ | ⊙ | ⊙ | ⊙ | ⊙ | ⊙ | ⊙ | ◯ | ⊙ | ⊙ | 10.9 | 18.3 |
| Example 1 | | | | | | | | | | | | | | | | | |
| Comparative | X | X | X | ⊙ | ⊙ | ⊙ | ⊙ | ⊙ | ⊙ | ⊙ | ⊙ | ⊙ | ◯ | ⊙ | ⊙ | 10.4 | 18.2 |
| Example 2 | | | | | | | | | | | | | | | | | |
| Comparative | ⊙ | ⊙ | ⊙ | ◯ | Δ | X | X | ◯ | Δ | X | X | Δ | X | X | X | 8.5 | 16.2 |
| Example 3 | | | | | | | | | | | | | | | | | |
| Comparative | ⊙ | ⊙ | ⊙ | Δ | X | Δ | Δ | X | X | Δ | Δ | X | X | Δ | Δ | 10.2 | 18.1 |
| Example 4 | | | | | | | | | | | | | | | | | |
| Comparative | ⊙ | ⊙ | ⊙ | Δ | X | Δ | Δ | Δ | X | Δ | Δ | X | X | Δ | Δ | 10.6 | 17.9 |
| Example 5 | | | | | | | | | | | | | | | | | |
| Comparative | ⊙ | ⊙ | ⊙ | ◯ | Δ | X | X | ◯ | Δ | X | X | Δ | X | X | X | 10.2 | 18.6 |
| Example 6 | | | | | | | | | | | | | | | | | |
| Comparative | ⊙ | ⊙ | ⊙ | ◯ | ◯ | X | X | ◯ | ◯ | X | X | ◯ | Δ | X | X | 10.5 | 17.7 |
| Example 7 | | | | | | | | | | | | | | | | | |
| Comparative | ⊙ | ⊙ | ⊙ | ◯ | X | X | X | ◯ | X | X | X | Δ | X | X | X | 5.2 | 8.2 |
| Example 8 | | | | | | | | | | | | | | | | | |
| Comparative | ⊙ | ⊙ | ⊙ | ⊙ | ◯ | ◯ | ⊙ | ⊙ | ◯ | ◯ | ⊙ | ⊙ | ◯ | ⊙ | ⊙ | 13.3 | 22 |
| Example 9 | | | | | | | | | | | | | | | | | |

Concerning the monomers used in the preparation of the acrylic polymer (A) in Table 1, BA represents butyl acrylate, BzA benzyl acrylate, AA acrylic acid, HBA 4-hydroxybutyl acrylate, and HEA 2-hydroxyethyl acrylate.

Concerning the crosslinking agent (B) in Table 1, “Isocyanate type” represents an isocyanate crosslinking agent (tolylene diisocyanate adduct of trimethylolpropane, Coronate L manufactured by Nippon Polyurethane Industry Co., Ltd.), “Peroxide type” benzoyl peroxide (Nyper BMT manufactured by NOF Corporation), and “Epoxy type” an epoxy crosslinking agent (diglycidylaminomethylcyclohexane, TETRAD C manufactured by Mitsubishi Gas Chemical Company, Inc.).

Concerning the silyl group-containing compound (C) in Table 1, “Silane coupling agent (C1)” represents KBM403 manufactured by Shin-Etsu Chemical Co., Ltd., and “Polyether compound (C2)” SILYL SAT10 manufactured by Kaneka Corporation. SILYL SAT10 corresponds to the compound represented by formula (4), in which A² is —C₃H₆—, Z¹ is —C₃H₆—Z⁰, the reactive silyl group (Z⁰—) is a dimethoxymethylsilyl group in which R¹, R² and R³ are all methyl groups, and it has a number average molecular weight of 5,000.

What is claimed is:

1. A pressure-sensitive adhesive optical film, comprising:
an optical film and
a pressure-sensitive adhesive layer,
wherein the pressure-sensitive adhesive layer is formed on at least one side of the optical film,
wherein the pressure-sensitive adhesive layer for an optical film, comprises a pressure-sensitive adhesive composition for an optical film, comprising a (meth)acrylic polymer (A) that comprises, as monomer units, 67 to 96.99% by weight of alkyl (meth)acrylate (a1), 4 to 20% by weight of benzyl (meth)acrylate (a2), 4 to 10% by weight of a carboxyl group-containing monomer (a3) and 0.1 to 1.5% by weight of a hydroxyl group-containing monomer (a4), has a weight average molecular weight (Mw) of 1,600,000 or more, and satisfy a weight average molecular weight (Mw)/number average molecular weight (Mn) ratio of 1.8 to 10; and,
the optical film comprises a triacetylcellulose resin, a (meth)acrylic resin or a norbornene resin.

2. The pressure-sensitive adhesive optical film according to claim 1, wherein the hydroxyl group-containing monomer (a4) comprises 4-hydroxybutyl (meth)acrylate.

3. The pressure-sensitive adhesive optical film according to claim 1, further comprising a crosslinking agent (B).

4. The pressure-sensitive adhesive optical film according to claim 3, wherein the crosslinking agent (B) comprises at least one selected from an isocyanate crosslinking agent, an epoxy crosslinking agent and a peroxide crosslinking agent.

5. The pressure-sensitive adhesive optical film according to claim 1, further comprising a silyl group-containing compound (C).

6. The pressure-sensitive adhesive optical film of claim 1, further comprising an undercoat layer that is provided between the optical film and the pressure-sensitive adhesive layer for the optical film.

7. An image display, comprising at least one piece of the pressure-sensitive adhesive optical film according to claim 1.
